(19) United States
(12) Patent Application Publication
(10) Pub. No.: US 2024/0370150 A1
(43) Pub. Date: Nov. 7, 2024

(54) INTERACTION PROCESSING

(71) Applicant: Tencent Technology (Shenzhen) Company Limited, Shenzhen (CN)

(72) Inventors: Mutian SHI, Shenzhen (CN); Mengyuan ZHANG, Shenzhen (CN)

(73) Assignee: Tencent Technology (Shenzhen) Company Limited, Shenzhen (CN)

(21) Appl. No.: 18/773,516

(22) Filed: Jul. 15, 2024

Related U.S. Application Data
(63) Continuation of application No. PCT/CN2023/113257, filed on Aug. 16, 2023.

(30) Foreign Application Priority Data
Sep. 23, 2022 (CN) 202211165140.5

(51) Int. Cl. G06F 3/04842; A63F 13/5372; A63F 13/55; A63F 13/822

(52) U.S. Cl. CPC G06F 3/04842; A63F 13/5372; A63F 13/55; A63F 13/822

(57) ABSTRACT

In an interaction processing method for a virtual scene, the virtual scene and at least one group control element are displayed. The virtual scene includes a plurality of groups. Identifiers of the plurality of groups are displayed when a first user selection operation is performed on a first group control element of the at least one group control element. Based on a first sliding operation passing through an identifier of a first group of the plurality of groups, the identifier of the first group is displayed in a selected state. The first sliding operation starts from an initial location of the first user selection operation while the first user selection operation is maintained. A travelling route of the first group is displayed in the selected state based on a released location of the first sliding operation when the user selection operation is released.

### RELATED APPLICATIONS

The present application is a continuation of International Application No. PCT/CN2023/113257, filed on Aug. 16, 2023, which claims priority to Chinese Patent Application No. 202211165140.5, filed on Sep. 23, 2022. The prior applications are hereby incorporated by reference in their entirety.

### FIELD OF THE TECHNOLOGY

This disclosure relates to computer technologies, including to an interaction processing method and apparatus for a virtual scene, an electronic device, a computer-readable storage medium, and a computer program product.

### BACKGROUND OF THE DISCLOSURE

A display technology based on graphics processing hardware expands channels for environment sensing and information obtaining. In particular, a virtual scene display technology can achieve diversified interactions between virtual objects controlled by a user or artificial intelligence based on an actual application demand, and is applicable to various typical application scenarios. For example, the display technology can emulate a real combat process between virtual objects in a virtual scene such as a game.

When a user performs a user selection operation on, such as clicks/taps, a plurality of controls on a human-computer interaction interface to control a virtual object in a virtual scene, if a plurality of types of options need to be selected, the user usually needs to click/tap or perform another operation on the plurality of controls a plurality of times, which causes high operation difficulty and low operation efficiency. In other words, the related art currently has no effective solution for a problem of low interaction efficiency in a virtual scene.

### SUMMARY

Embodiments of this disclosure provide an interaction processing method and apparatus for a virtual scene, an electronic device, a non-transitory computer-readable storage medium, and a computer program product, which can improve interaction efficiency in a virtual scene.

Technical solutions in the embodiments of this disclosure may be implemented as follows:

An embodiment of this disclosure provides an interaction processing method for a virtual scene. The interaction processing method may be performed by an electronic device, for example. In the interaction processing method, the virtual scene and at least one group control element are displayed. The virtual scene includes a plurality of groups. Identifiers of the plurality of groups are displayed when a first user selection operation is performed on a first group control element of the at least one group control element. Based on a first sliding operation passing through an identifier of a first group of the plurality of groups, the identifier of the first group is displayed in a selected state. The first sliding operation starts from an initial location of the first user selection operation while the first user selection operation is maintained. A travelling route of the first group is displayed in the selected state based on a released location of the first sliding operation when the user selection operation is released. The travelling route is set through the first sliding operation.

An embodiment of this disclosure provides an information processing apparatus for a virtual scene. The information processing apparatus is an interaction processing apparatus, for example. The information processing apparatus includes processing circuitry that is configured to display the virtual scene and at least one group control element, the virtual scene including a plurality of groups. The processing circuitry is configured to display identifiers of the plurality of groups when a first user selection operation is performed on a first group control element of the at least one group control element. The processing circuitry is configured to display, based on a first sliding operation passing through an identifier of a first group of the plurality of groups, the identifier of the first group in a selected state, the first sliding operation starting from an initial location of the first user selection operation while the first user selection operation is maintained. The processing circuitry is configured to display a travelling route of the first group in the selected state based on a released location of the first sliding operation when the user selection operation is released, the travelling route being set through the first sliding operation.

An embodiment of this disclosure provides an electronic device, including a memory and a processor. The memory is configured to store computer-executable instructions. The processor is configured to perform the interaction processing method for a virtual scene provided in the embodiments of this disclosure when executing the computer-executable instructions stored in the memory.

An embodiment of this disclosure provides a non-transitory computer-readable storage medium, storing instructions which when executed by a processor cause the processor to perform the interaction processing method for a virtual scene provided in the embodiments of this disclosure.

An embodiment of this disclosure provides a computer program product, including a computer program or computer-executable instructions, the computer program or computer-executable instructions, when executed by a processor, implementing the interaction processing method for a virtual scene provided in the embodiments of this disclosure.

Embodiments of this disclosure include the following beneficial effects:

Selection of two different types of options, namely, a team and a route is achieved through the first sliding operation starting from the first team control Compared to a traditional manner in which only one type of option can be selected through each operation, setting the travelling route of the first team through the first sliding operation reduces operations, improves interaction efficiency in the virtual scene, and reduces computing resources required for the virtual scene. In this way, operation difficulty is reduced for a user, and a degree of selection freedom of the user is improved, thereby improving usage experience of the user.

### BRIEF DESCRIPTION OF THE DRAWINGS

FIG. 1A is a schematic diagram of an application mode of an interaction processing method for a virtual scene according to an embodiment of this disclosure.

FIG. 1B is a schematic diagram of an application mode of an interaction processing method for a virtual scene according to an embodiment of this disclosure.

FIG. 2 is a schematic structural diagram of a terminal device 400 according to an embodiment of this disclosure.

FIG. 3A to FIG. 3G are schematic flowcharts of an interaction processing method for a virtual scene according to an embodiment of this disclosure.

FIG. 4A to FIG. 4B are schematic flowcharts of an interaction processing method for a virtual scene according to an embodiment of this disclosure.

FIG. 5A to FIG. 5G are schematic diagrams of a human-computer interaction interface according to an embodiment of this disclosure.

FIG. 6A to FIG. 6B are schematic flowcharts of an interaction processing method for a virtual scene according to an embodiment of this disclosure.

FIG. 7A to FIG. 7D are schematic diagrams of a human-computer interaction interface according to an embodiment of this disclosure.

### DESCRIPTION OF EMBODIMENTS

To make objectives, technical solutions, and advantages of this disclosure clearer, this disclosure is further described with reference to drawings. The described embodiments are not to be construed as a limitation on this disclosure. Other embodiments fall within the protection scope of this disclosure.

In the following description, “some embodiments” is involved, which describes subsets of all possible embodiments, but “some embodiments” may be the same subset or different subsets of all of the possible embodiments, and may be combined with each other without conflict.

In the following description, a term “first/second/third” involved is merely configured for distinguishing between similar objects, and does not represent a specific order of objects. “First/second/third” may be transposed in a specific order or a sequence when allowed, so that the embodiments of this disclosure described herein may be implemented in an order other than those illustrated or described herein.

Unless otherwise defined, meanings of all technical and scientific terms used in this specification are the same as those usually understood by a person skilled in the art of this disclosure. The terms used in this specification are merely intended to describe the objectives of the embodiments of this disclosure, and are not intended to limit this disclosure.

Before the embodiments of this disclosure are further described, examples of the terms involved in the embodiments of this disclosure are described. The terms involved in the embodiments of this disclosure are applicable to the following explanations. The descriptions of the terms are provided as examples only and are not intended to limit the scope of the disclosure

Virtual scene: It is a scene different from the real world outputted by using a device. Visual sensing of the virtual scene may be formed through naked eyes or assistance of a device, for example, a two-dimensional image outputted by a display, and a three-dimensional image outputted by using stereoscopic display technologies such as stereoscopic projection, virtual reality, and augmented reality. In addition, various sensing emulating the real world such as auditory sensing, tactile sensing, olfactory sensing, and motion sensing may be formed through various possible hardware. The virtual scene may be a virtual game scene.

In response to: It is configured for indicating a condition or a state on which one or more to-be-performed operations rely. When the condition or the state is satisfied, the one or more operations may be performed in real time or have a set delay. Unless otherwise specified, an order in which a plurality of operations are performed is not limited.

Virtual object: It is an object that performs interactions in a virtual scene, which is controlled by a user or a robot program (such as an artificial intelligence-based robot program), and can keep still, move, and perform various behaviors in the virtual scene, and may be, for example, various roles in a game. For example, the virtual object is a user-controlled virtual object or virtual monster, or may be a non-player character (NPC).

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Embodiments of this disclosure provide an interaction processing method for a virtual scene, an interaction processing apparatus for a virtual scene, an electronic device, a computer-readable storage medium, and a computer program product, which can improve interaction efficiency in a virtual scene.

An example of an application of the electronic device provided in the embodiments of this disclosure is described below. The electronic device provided in the embodiments of this disclosure may be implemented as various types of user terminals (that is, terminal devices) such as a notebook computer, a tablet computer, a desktop computer, a set-top box, a mobile device (such as a mobile phone, a portable music player, a personal digital assistant, a dedicated messaging device, or a portable game device), or an on-board terminal, or may be implemented as a server. An example of an application of independently implementing the embodiments of this disclosure by a terminal device and an example of an application of collaboratively implementing the embodiments of this disclosure by a terminal device and a server are respectively described below.

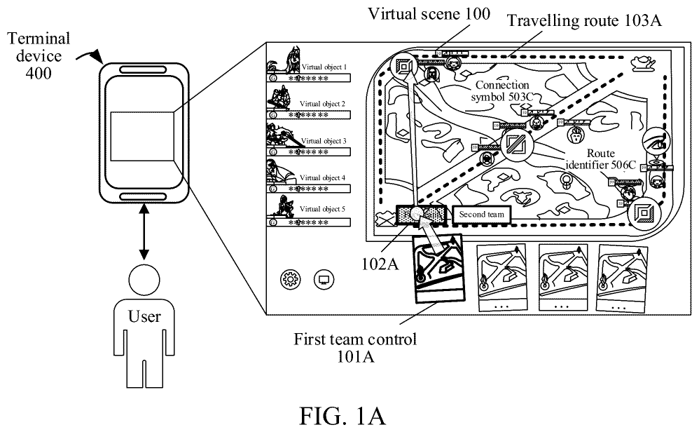

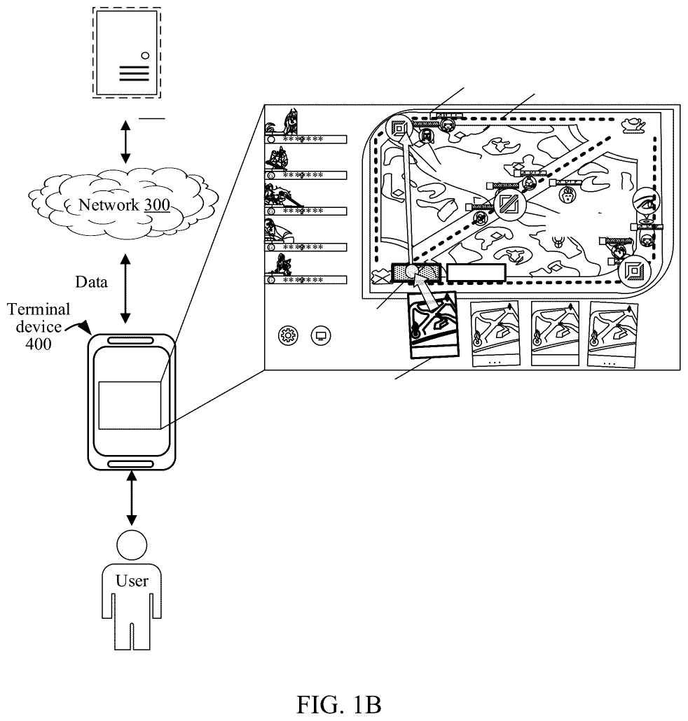

In an implementation scenario, FIG. 1A is a schematic diagram of an application mode of an interaction processing method for a virtual scene according to an embodiment of this disclosure. The method is applicable to application modes in which calculation of data related to a virtual scene can be completed merely through a computing capability of graphics processing hardware of a terminal device 400. For example, in a game in a stand-alone mode/an off-line mode, outputting of a virtual scene is completed through various types of terminal devices 400 such as a smartphone, a tablet computer, and a virtual reality/augmented reality device.

In an example, types of the graphics processing hardware include a central processing unit (CPU) and a graphics processing unit (GPU).

When visual sensing of the virtual scene needs to be formed, the terminal device 400 calculates data for display through the graphics computing hardware, completes loading, parsing, and rendering of the displayed data, and outputs a video frame that can form the visual sensing of the virtual scene on the graphics output hardware. For example, a two-dimensional video frame is presented on a display of a smartphone, or a three-dimensional video frame is projected onto lenses of augmented reality/virtual reality glasses. In addition, to enrich a sensing effect, the terminal device 400 may further form one or more of auditory sensing, tactile sensing, motion sensing, and taste sensing through different hardware.

In an example, a client (for example, a stand-alone game application) runs in the terminal device 400. A virtual scene including role play is outputted during the running of the client. The virtual scene may be an environment for interactions between game roles, for example, may be a plain, a street, or a valley for battles between game roles. A first virtual object may be a user-controlled game role. To be specific, the first virtual object is controlled by a real user, and moves in the virtual scene in response to an operation performed by the real user on a controller (such as a touch screen, a voice-operated switch, a keyboard, a mouse, and a joystick). For example, when the real user moves the joystick rightward, the first virtual object moves rightward in the virtual scene. The first virtual object can further keep still and jump, and be controlled to perform a shooting operation, and the like.

The virtual scene may be a virtual game scene, the user may be a player, and a plurality of teams may be teams controlled by players. Each team includes at least one virtual object. The virtual object may be a virtual object controlled by another player or artificial intelligence. A description is provided below in combination with the above examples.

In an example, referring to FIG. 1A, the terminal device 400 displays a virtual scene 100 on a human-computer interaction interface, and displays at least one team control, the virtual scene including a plurality of teams participating in an interaction. The user performs a user selection operation, such as clicks/taps, a first team control 101A, so that the human-computer interaction interface of the terminal device 400 displays identifiers of the plurality of teams. In a case that the clicking/tapping operation is maintained, the terminal device 400 receives a sliding operation performed starting from a clicking/tapping location of the clicking/tapping operation, and displays, in response to the sliding operation passing through an identifier 102A of a first team, the identifier 102A of the first team in a selected state. The terminal device 400 displays a travelling route 103A of the first team in the selected state in response to the sliding operation being released, the travelling route 103A being set through the above sliding operation. In this way, selection operations for two different types of options are achieved through a single sliding operation, which improves the interaction efficiency in the virtual scene.

Before FIG. 1B is described, a game mode involved in the solution collaboratively implemented by the terminal device and the server is described. The solution collaboratively implemented by the terminal device and the server mainly involves two game modes, namely, a local game mode and a cloud game mode. The local game mode means that the terminal device and the server collaboratively a game processing logic. To be specific, for an operation instruction inputted by a player in the terminal device, the terminal device runs a part of the game processing logic, and the server runs an other part of the game processing logic. The game processing logic run by the server is often more complex and requires a greater computing power. The cloud game mode means that the game processing logic is completely run by the server, and game scene data is rendered into an audio/video stream by a cloud server and then transmitted to the terminal device through a network for display. The terminal device of the player only needs to have a basic streaming media playback capability and a capability of obtaining instructions of players and transmitting the instructions to the cloud server.

In another implementation scenario, FIG. 1B is a schematic diagram of an application mode of an interaction processing method for a virtual scene according to an embodiment of this disclosure. The method is applied to a terminal device 400 and a server 200, and is applicable to an application mode in which calculation of the virtual scene is completed through a computing capability of the server 200 and the virtual scene is outputted at the terminal device 400.

An example in which visual sensing of the virtual scene is formed is used. The server 200 calculates display data (such as scene data) related to the virtual scene and transmits the display data to the terminal device 400 through a network 300. The terminal device 400 completes loading, parsing, and rendering of the calculated display data through graphics computing hardware, and outputs the virtual scene through graphics output hardware to form the visual sensing. For example, a two-dimensional video frame may be presented on a display of a smartphone, or a three-dimensional video frame is projected onto lenses of augmented reality/virtual reality glasses. Sensing in the form of the virtual scene may be outputted by using corresponding hardware of the terminal device 400. For example, auditory sensing is formed by using a microphone, and haptic sensing is formed by using a vibrator.

In an example, a client (for example, an online game application) runs in the terminal device 400. A virtual scene including role play is outputted during the running of the client. The virtual scene may be an environment for interactions between game roles, for example, may be a plain, a street, or a valley for battles between game roles. A first virtual object may be a user-controlled game role. To be specific, the first virtual object is controlled by a real user, and moves in the virtual scene in response to an operation performed by the real user on a controller (such as a touch screen, a voice-operated switch, a keyboard, a mouse, and a joystick). For example, when the real user moves the joystick rightward, the first virtual object moves rightward in the virtual scene. The first virtual object can further keep still and jump, and be controlled to perform a shooting operation and use a virtual skill, and the like.

The virtual scene may be a virtual game scene, the server 200 may be a server of a game platform, the user may be a player, and a plurality of teams may be teams controlled by players. Each team includes at least one virtual object. The virtual object may be a virtual object controlled by another player or artificial intelligence. A description is provided below in combination with the above examples.

In an example, the server 200 runs a game progress, and transmits data of a corresponding game picture to the terminal device 400. The terminal device 400 displays a virtual scene 100 on a human-computer interaction interface, and displays at least one team control, the virtual scene including a plurality of teams participating in an interaction. The user clicks/taps a first team control 101A, so that the human-computer interaction interface of the terminal device 400 displays identifiers of the plurality of teams. In a case that the clicking/tapping operation is maintained, the terminal device 400 receives a sliding operation performed starting from a clicking/tapping location of the clicking/tapping operation, and displays, in response to the sliding operation passing through an identifier 102A of a first team, the identifier 102A of the first team in a selected state. The terminal device 400 displays a travelling route 103A of the first team in the selected state in response to the sliding operation being released, the travelling route being set through the above sliding operation. In this way, selection operations for two different types of options are achieved through a single sliding operation, which improves the interaction efficiency in the virtual scene.

In some embodiments, the terminal device 400 may implement the interaction processing method for a virtual scene provided in the embodiments of this disclosure by running a computer program. For example, the computer program may be a native program or a software module in an operating system, or may be a native application (APP), i.e., a program that needs to be installed in the operating system for running, such as a card game APP, or may be an applet, i.e., a program that only needs to be downloaded into a browser environment for running, or may be a game applet that can be embedded in any APP. In a word, the above computer program may be an APP, a module, or a plug-in in any form.

An example in which the computer program is an APP is used. In an actual implementation, the terminal device 400 has an APP supporting a virtual scene installed and running therein. The APP may be any one of a first-person shooting game (FPS), a third-person shooting game, a virtual reality APP, a three-dimensional map program, or a multiplayer survival game. A user controls a virtual object located in the virtual scene to perform an activity by using the terminal device 400. The activity includes but is not limited to at least one of adjusting a body posture, crawling, walking, running, riding, jumping, driving, pickup, shooting, attacking, throwing, and constructing a virtual building. In an example, the virtual object may be a virtual character, such as a simulated character or a cartoon character.

In some embodiments, the server may be an independent physical server, or may be a server cluster formed by a plurality of physical servers or a distributed system, or may be a cloud server providing basic cloud computing services such as a cloud service, a cloud database, cloud computing, a cloud function, cloud storage, a network service, cloud communication, a middleware service, a domain name service, a security service, a content delivery network (CDN), a big data platform, and an artificial intelligence platform. The terminal device may be a smartphone, a tablet computer, a notebook computer, a desktop computer, a smart speaker, a smartwatch, an on-board terminal, or the like, but is not limited thereto. The terminal device and the server may be directly or indirectly connected through wired or wireless communication, which is not limited in this embodiment of this disclosure.

This embodiment of this disclosure may be further implemented through a cloud technology. The cloud technology is a collective name of a network technology, an information technology, an integration technology, a platform management technology, an application technology, and the like based on application of business models for cloud computing. The technologies may form a resource pool for use on demand, which is flexible and convenient. A cloud computing technology becomes an important support. Backend services of a technology network system such as a video website, a picture website, and more portal websites require a lot of computing and storage resources. With the high development and application of the Internet industry and the promotion by demands such as a search service, a social network, mobile commerce, and open collaboration, each item may have an identification mark in a form of a hash code, which needs to be transmitted to a backend system for logical processing, data of different levels is processed separately, and all kinds of industry data require support of a strong system, which can be achieved through only the cloud computing.

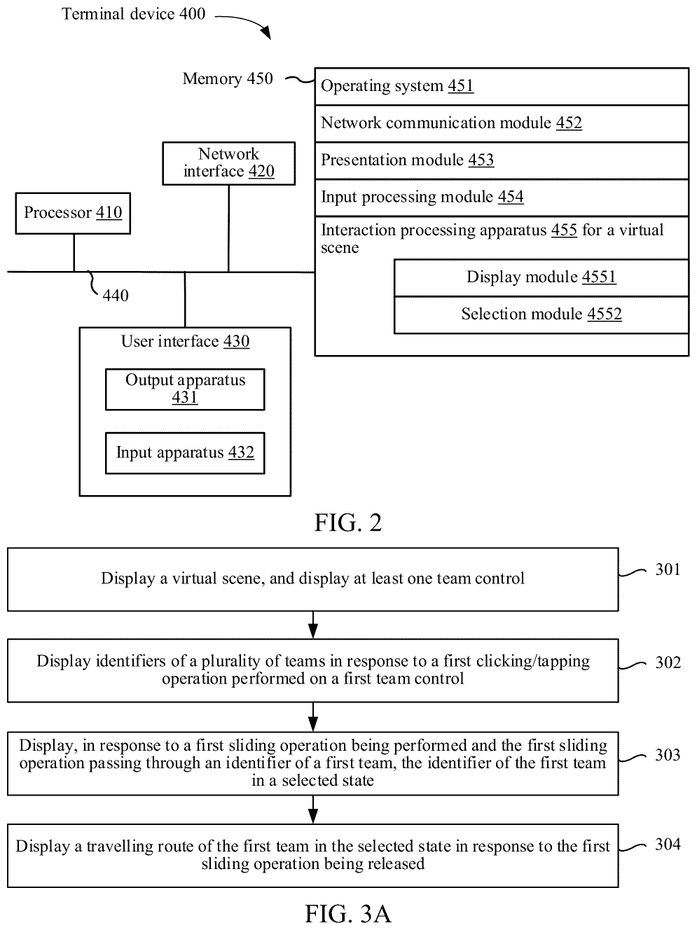

FIG. 2 is a schematic structural diagram of a terminal device 400 according to an embodiment of this disclosure. The terminal device 400 shown in FIG. 2 includes processing circuitry (such as at least one processor 410), a memory 450, at least one network interface 420, and a user interface 430. Components in the terminal device 400 are coupled together through a bus system 440. The bus system 440 is configured to implement connection and communication between the components. In addition to a data bus, the bus system 440 further includes a power bus, a control bus, and a status signal bus. However, for clarity, all buses are marked as the bus system 440 in FIG. 2.

The processor 410 may be an integrated circuit chip with a signal processing capability, for example, a general-purpose processor, a digital signal processor (DSP), another programmable logic device, a discrete gate, a transistor logic device, or a discrete hardware component. The general-purpose processor may be a microprocessor, any conventional processor, or the like.

The user interface 430 includes one or more output apparatuses 431 that can present media content, including one or more speakers and/or one or more visual displays. The user interface 430 further includes one or more input apparatuses 432, including user interface components that facilitate user input, such as a keyboard, a mouse, a microphone, a touch display, a camera, another input button, and a control.

The memory 450 may be removable, non-removable, or a combination thereof. An example of a hardware device includes a solid-state memory, a hard disk drive, an optical disk drive, and the like. In some embodiments, the memory 450 includes one or more storage devices that are physically away from the processor 410.

The memory 450 includes a volatile memory or a non-volatile memory, or may include both the volatile memory and the non-volatile memory. The non-volatile memory may be a read-only memory (ROM). The volatile memory may be a random access memory (RAM). The memory 450 described in this embodiment of this disclosure is intended to include any suitable type of memory.

In some embodiments, the memory 450 can store data to support various operations. Examples of the data include a program, a module, and a data structure, or a subset or a superset thereof. An example description is provided below.

An operating system 451 includes system programs configured to process basic system services and perform hardware-related tasks, such as a framework layer, a core library layer, and a drive layer, and is configured to implement basic services and process hardware-based tasks.

A network communication module 452 is configured to arrive at another electronic device through one or more (wired or wireless) network interfaces 420. Examples of network interfaces 420 include Bluetooth, Wi-Fi, and a universal serial bus (USB).

A presentation module 453 is configured to enable presentation of information through one or more output apparatuses 431 (for example, a display and a speaker) associated with the user interface 430 (for example, a user interface configured to operate a peripheral device and display content and information).

An input processing module 454 is configured to detect one or more user inputs or interactions from one of the one or more input apparatuses 432 and translate the detected inputs or interactions.

In some embodiments, an interaction processing apparatus for a virtual scene provided in the embodiments of this disclosure may be implemented by software. FIG. 2 shows an interaction processing apparatus 455 for a virtual scene stored in a memory 450, which may be software in a form of a program and a plug-in, and includes a display module 4551 and a selection module 4552. The modules are logical and may be combined in different manners or further split based on to-be-implemented functions to form other embodiments. Functions of the modules are described below.

The interaction processing method for a virtual scene provided in the embodiments of this disclosure is described in combination with examples of applications and implementations of the terminal device provided in the embodiments of this disclosure.

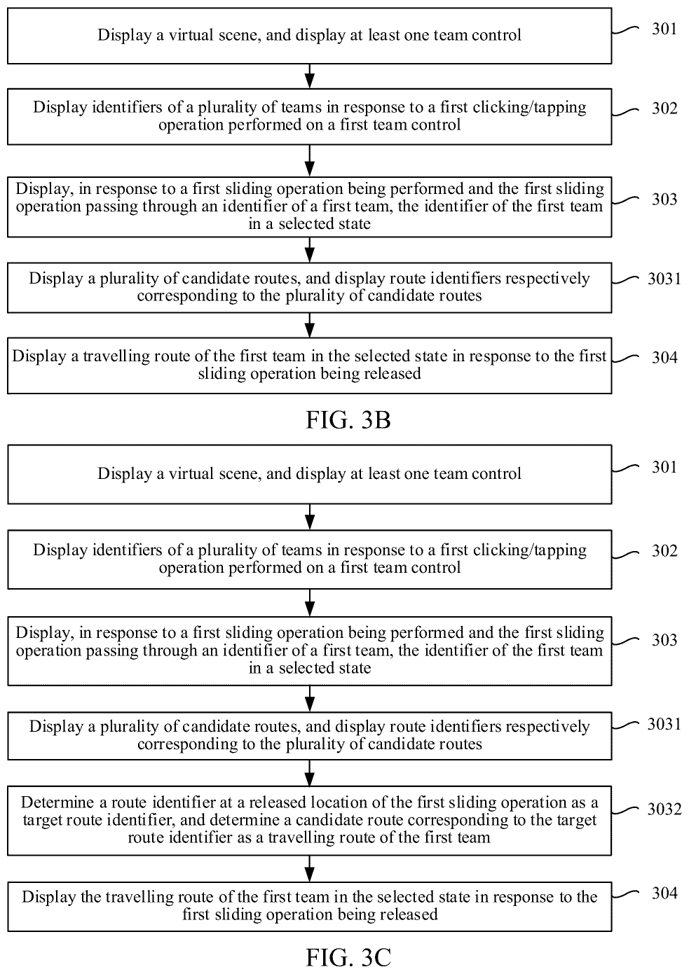

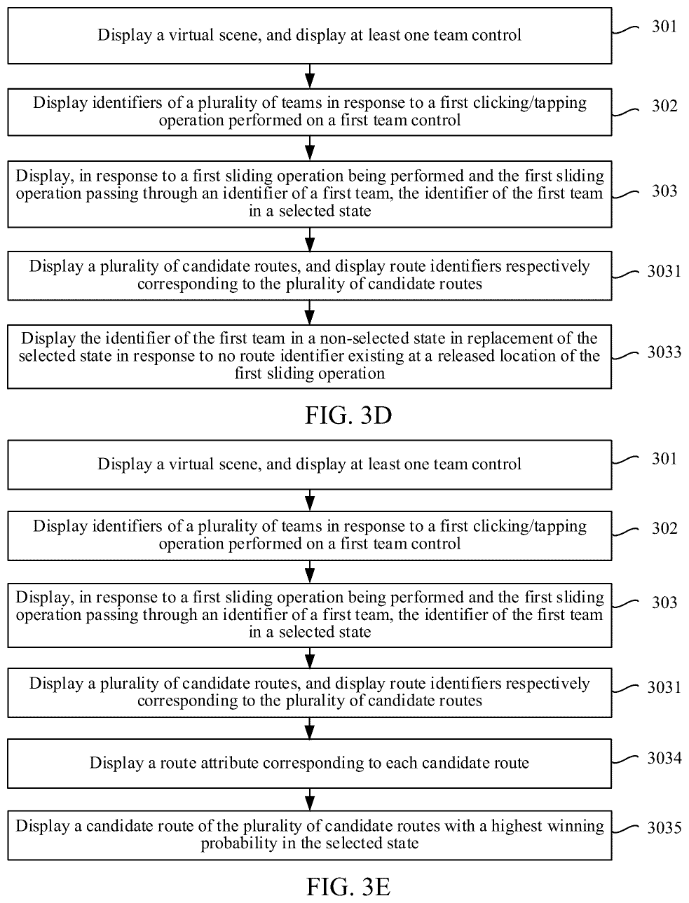

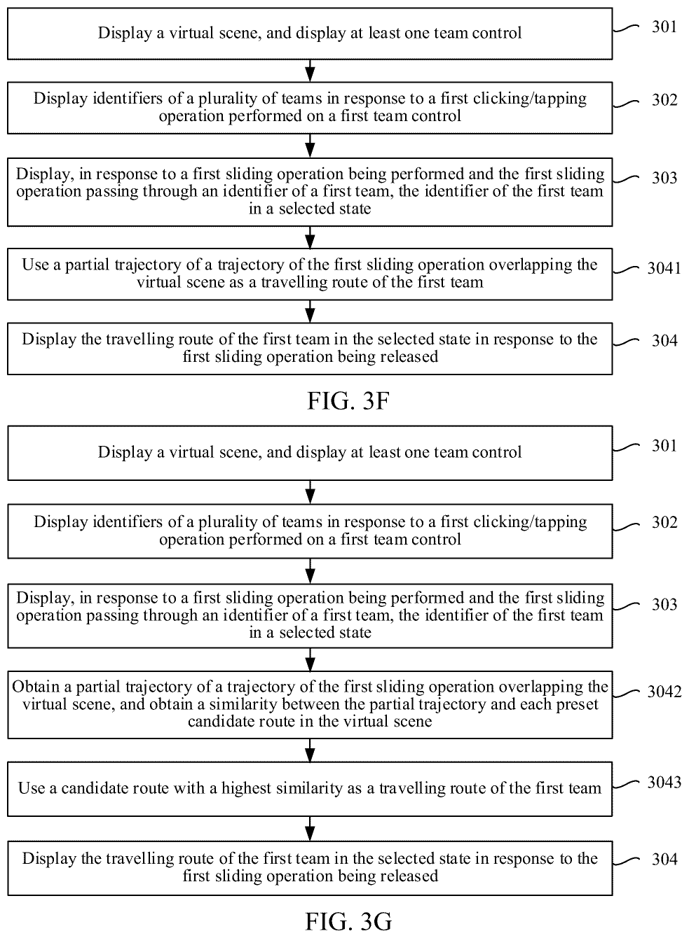

FIG. 3A is a schematic flowchart of an interaction processing method for a virtual scene according to an embodiment of this disclosure. A description is provided with reference to operations shown in FIG. 3A by using an example in which the method is performed by the terminal device 400 in FIG. 1A.

Operation 301: Display a virtual scene, and display at least one team control. In an example, the virtual scene and at least one group control element are displayed.

In an example, the virtual scene may be a virtual game scene, and the virtual scene may include a plurality of groups (such as teams) participating in an interaction. Each group (or team) includes at least one virtual object.

In some embodiments, different team controls correspond to different team assignment manners of a plurality of virtual objects in a first camp, and the plurality of teams are obtained by assigning the plurality of virtual objects in the first camp based on a team assignment manner of the first team control. The team assignment manner is an assignment manner of assigning a plurality of virtual objects in the same camp to different teams. The first camp may be a camp in which a user (i.e., a virtual object controlled by a user) is located, and the second camp may be a rival camp or a partner camp of the first camp. A description is provided based on the above example.

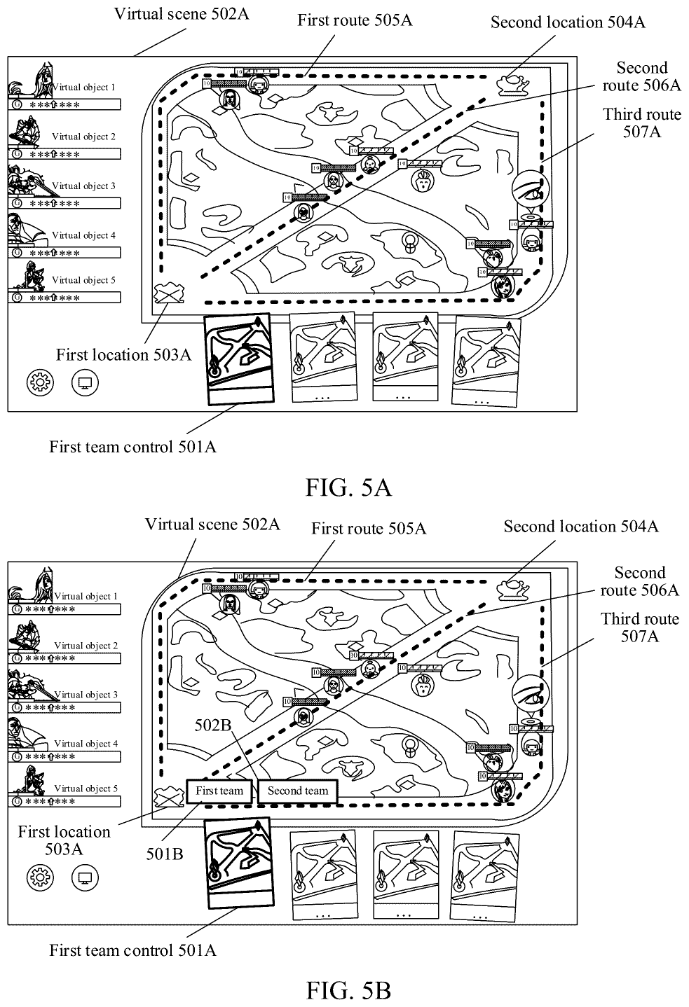

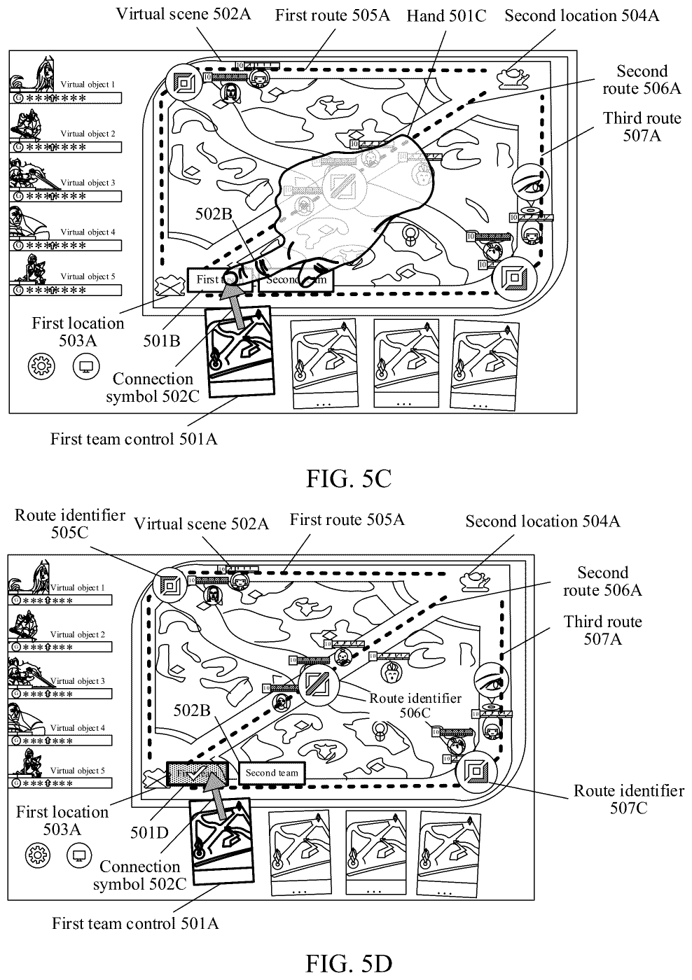

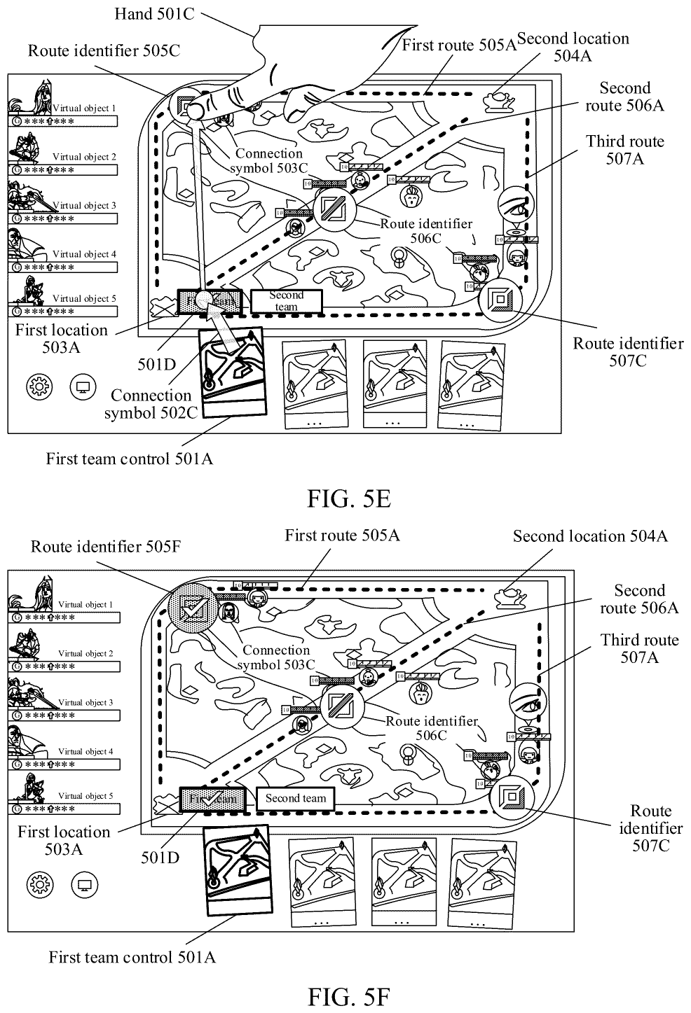

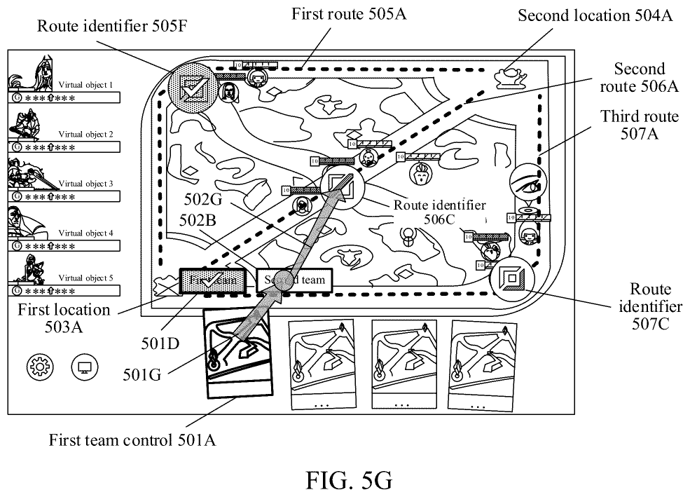

In an example, FIG. 5A is a schematic diagram of a human-computer interaction interface according to an embodiment of this disclosure. A human-computer interaction interface of the terminal device 400 displays a virtual scene 502A and a plurality of team controls including a first team control 501A. The virtual scene 502A includes two different camps. A position of the first camp is at a first location 503A, and a position of the second camp is at a second location 504A. The first camp includes a virtual object 1, a virtual object 2, a virtual object 3, a virtual object 4, and a virtual object 5. Names and information of the virtual objects are displayed on a side of the virtual scene for viewing by the user.

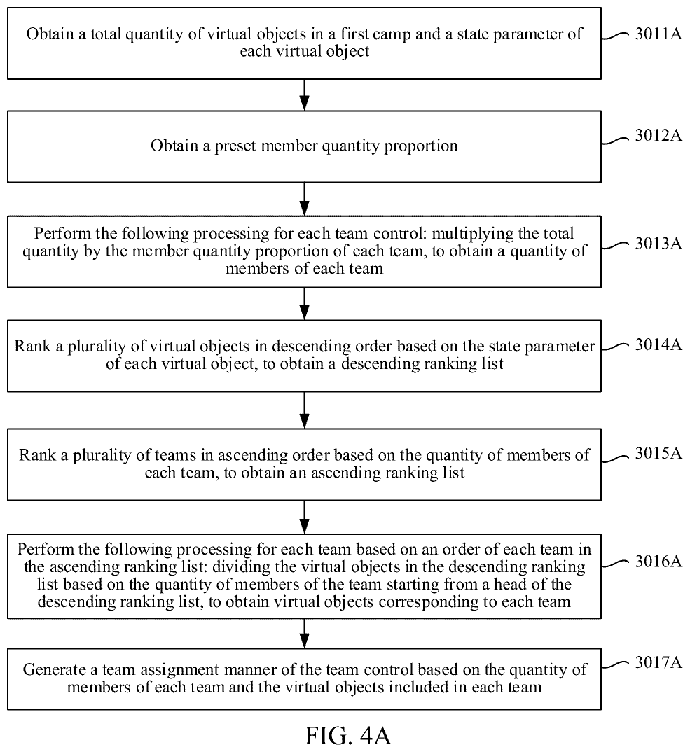

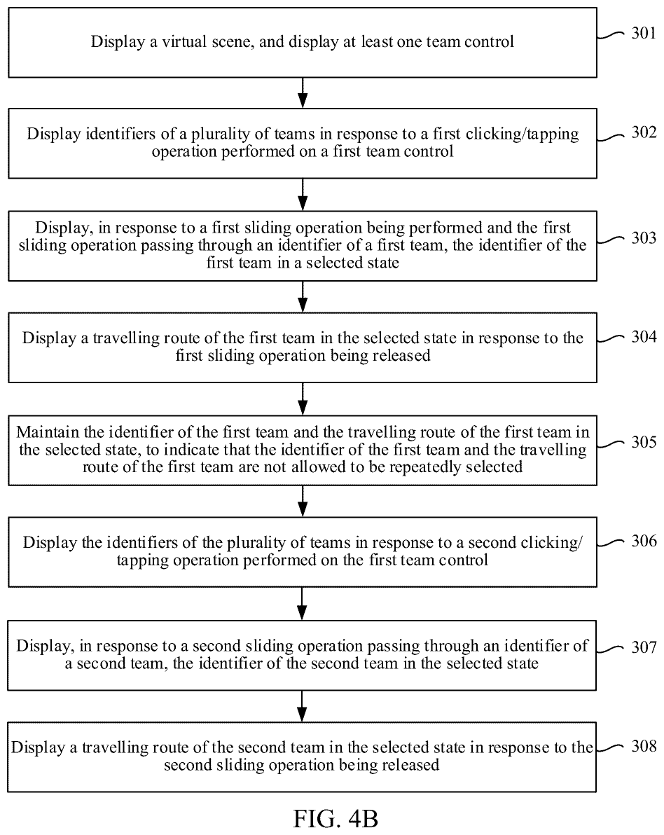

In some embodiments, FIG. 4A is a schematic flowchart of an interaction processing method for a virtual scene according to an embodiment of this disclosure. Before operation 301, a team assignment manner corresponding to each team control is determined through the following operation 3011A to operation 3017A. Details are described below.

Operation 3011A: Obtain a total quantity of virtual objects in a first camp and a state parameter of each virtual object.

In an example, a camp may include more or fewer virtual objects. In this embodiment of this disclosure, a description is provided below by using an example in which the total quantity of virtual objects in the first camp is 5 (corresponding to FIG. 5A). The state parameter of the virtual object includes at least one of a health point, an attack power, and a quantity of virtual resources (for example, virtual coins) owned by the virtual object.

Operation 3012A: Obtain a preset member quantity proportion.

In an example, the member quantity proportion is a proportion of a quantity of members of each team corresponding to a team control to a total quantity. For example, a team control is configured to assign a plurality of virtual objects of a camp into two teams, which include a first team and a second team. A member quantity proportion of the first team is P1, and a member quantity proportion of the second team is P2. P1 and P2 are numerical values greater than 0 and less than 1, and P1+P2=1.

Operation 3013A: Perform the following processing for each team control: multiplying the total quantity by the member quantity proportion of each team, to obtain the quantity of members of each team.

In an example, a description is provided still based on the above example. Assuming that P1 is 0.2 and P2 is 0.8, a quantity of members of the first team is 5*0.2=1, and a quantity of members of the second team is 5*0.8=4.

Operation 3014A: Rank a plurality of virtual objects in descending order based on the state parameter of each virtual object, to obtain a descending ranking list.

In an example, the following processing is performed for each virtual object: performing weighted summation on all types of state parameters of the virtual object, and using a value obtained through the weighted sum summation as a state parameter sum of the virtual object; and ranking the plurality of virtual objects in the first camp in descending order based on the state parameter sums ranked in descending order, to obtain a descending ranking list of the virtual objects. For example, the state parameter sum of the virtual object may be calculated in the following manner:

The state parameter sum=0.6*the health point+0.2*the attack power+0.2*the quantity of virtual resources owned by the virtual object.

Operation 3015A: Rank a plurality of teams in ascending order based on the quantity of members of each team, to obtain an ascending ranking list.

In an example, an order of a team in the ascending ranking list represents an order in which a virtual object is assigned to a team. For example, if the quantity of members of the first team is 1 and the quantity of members of the second team is 4, an order of the first team in the ascending ranking list is 1, and an order of the second team in the ascending ranking list is 2. Based on the above orders, a virtual object assigned to the first team has a higher state parameter than a virtual object assigned to the second team.

Operation 3016A: Perform the following processing for each team based on an order of each team in the ascending ranking list: assigning the virtual objects in the descending ranking list based on the quantity of members of the team starting from a head of the descending ranking list, to obtain virtual objects corresponding to each team.

In an example, assuming that an order of the virtual objects in the descending ranking list is the virtual object 3, the virtual object 2, the virtual object 1, the virtual object 4, and the virtual object 5, a virtual object with an order of 1 (i.e., the virtual object 3) in the descending ranking list is assigned to the first team, and virtual objects with orders of 2 to 5 (i.e., the virtual object 2, the virtual object 1, the virtual object 4, and the virtual object 5) in the descending ranking list are assigned to the second team.

Operation 3017A: Generate a team assignment manner of the team control based on the quantity of members of each team and the virtual objects included in each team.

In an example, the quantity of members of each team and the virtual object included in each team are associated with the teams, and the quantities of members corresponding to each team and the virtual object corresponding to each team are associated with the team control. In response to the team control being triggered, virtual objects in a camp are automatically assigned to corresponding teams based on the team assignment manner.

In this embodiment of this disclosure, through the above team assignment manner, virtual objects with higher capabilities are assigned to a team with few members, so that each team has an equal capability, which facilitates improvement of efficiency of a battle, thereby reducing computing resources required for the virtual scene.

In some embodiments, when the at least one team control includes a plurality of team controls, the displaying at least one team control may be implemented in the following manner: displaying a team control corresponding to a recommended team assignment manner in the selected state; and displaying a team control corresponding to a non-recommended team assignment manner in a non-selected state.

In an example, the selected state may be represented in a display manner different from that of another team control, for example, highlighting, a bold line, displaying in another color, or displaying with an animation effect.

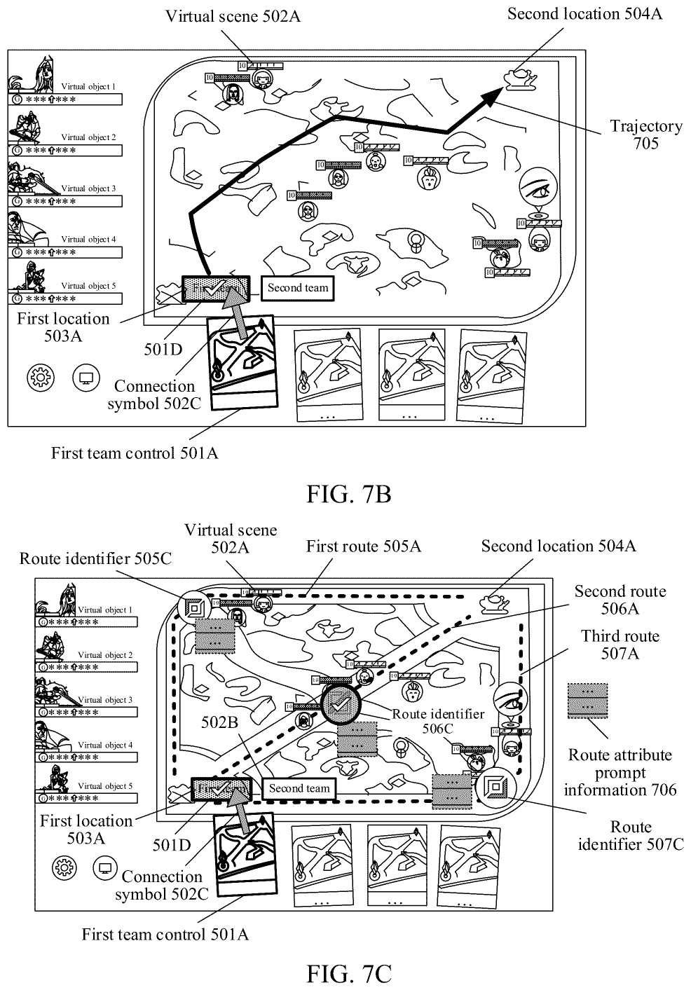

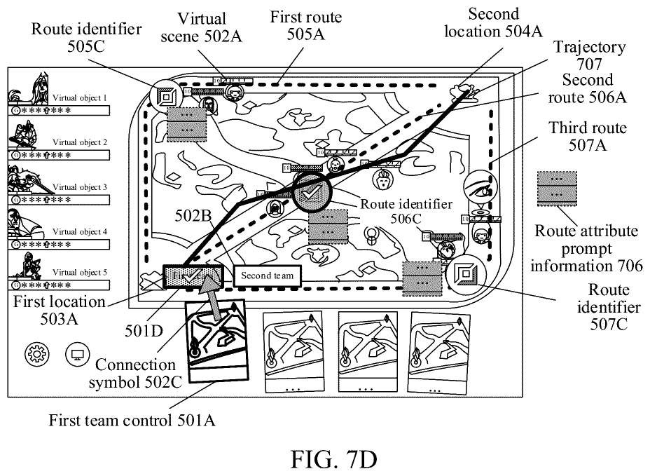

FIG. 7A is a schematic diagram of a human-computer interaction interface according to an embodiment of this disclosure. A control 701, a control 702, a control 703, and a control 704 are different team controls. The control 701 is the team control corresponding to the recommended team assignment manner displayed in the selected state (for example, in a form of a bold line). The control 702, the control 703, and the control 704 are team controls displayed in the non-selected state.

In some embodiments, before operation 301, the recommended team assignment manner may be determined in the following manner: calling a second machine learning model based on current battle data of the virtual scene to perform policy prediction, to obtain the recommended team assignment manner.

In an example, the current battle data includes a total quantity of virtual objects in a first camp, a total quantity of virtual objects in a second camp, a state parameter of each virtual object in the first camp, and a state parameter of each virtual object in the second camp. The second camp is a rival camp of the first camp.

The second machine learning model is trained based on battle data. The battle data includes team assignment manners of different camps in at least one battle, a state parameter of a virtual object of each team, and a battle result. A label corresponding to a team assignment manner of a victorious camp is 1, and a label corresponding to a team assignment manner of a defeated camp is 0.

In an example, the second machine learning model may be a neural network model (for example, a convolutional neural network, a deep convolutional neural network, or a fully connected neural network), a decision tree model, a gradient lifting tree, a multi-layer perceptron, a support vector machine, or the like. The type of the second machine learning model is not specifically limited in this embodiment of this disclosure.

In some embodiments, the recommended team assignment manner includes at least one of a team assignment manner with a highest winning probability, a team assignment manner with a highest usage frequency, and a team assignment manner used last time.

Still refer to FIG. 3A. Operation 302: Display identifiers of the plurality of teams in response to a first clicking/tapping operation performed on a first team control. In an example, identifiers of the plurality of groups are displayed when a first user selection operation is performed on a first group control element of the at least one group control element.

In an example, the plurality of teams respectively corresponding to the displayed identifiers of the plurality of teams belong to the same camp, and the identifier may be an icon. FIG. 5B is a schematic diagram of a human-computer interaction interface according to an embodiment of this disclosure. When the first clicking/tapping operation performed on the first team control 501A is received, compared to FIG. 5A, the first team control 501A moves upward from a plurality of team controls to indicate that the first team control 501A is selected, and an identifier 501B of the first team and an identifier 502B of the second team are displayed.

Operation 303: Display, in response to a first sliding operation being performed and the first sliding operation passing through an identifier of a first team, the identifier of the first team in a selected state. Based on a first sliding operation passing through an identifier of a first group of the plurality of groups, the identifier of the first group is displayed in a selected state. The first sliding operation starts from an initial location of the first user selection operation while the first user selection operation is maintained.

In an example, the first sliding operation is performed starting from a clicking/tapping location of the first clicking/tapping operation while the first clicking/tapping operation being maintained. The selected state may be displayed in the following manner: highlighting, an animation effect, a bold line, or the like.

FIG. 5C is a schematic diagram of a human-computer interaction interface according to an embodiment of this disclosure, to represent a relationship between an operation performed by a hand of a user and a picture displayed on the human-computer interaction interface. A hand 501C of the user performs a first sliding operation from a location of the first team control 501A through a finger while a clicking/tapping operation being maintained. FIG. 5D is a schematic diagram of a human-computer interaction interface according to an embodiment of this disclosure. A picture on the human-computer interaction interface in FIG. 5D is the same as that in FIG. 5C. When the first sliding operation passes through the identifier 501B of the first team, the identifier 501B of the first team is displayed in the selected state, which is represented as an identifier 501D of the first team in FIG. 5D.

In some embodiments, before the first sliding operation passes through the identifier of the first team, a connection symbol starting from the first team control and pointing to a current contact location of the first sliding operation is displayed.

In an example, the connection symbol may be an arrow. Still referring to FIG. 5C, a connection symbol 502C is displayed between a contact location of the first sliding operation and a starting location of the first sliding operation (i.e., the location of the first team control 501A).

In some embodiments, when the first sliding operation passes through the identifier of the first team, a connection symbol starting from the first team control, passing through the identifier of the first team, and pointing to the current contact location of the first sliding operation is displayed. FIG. 5E is a schematic diagram of a human-computer interaction interface according to an embodiment of this disclosure. The current contact location of the first sliding operation is at a location of a route identifier 505C. A connection symbol 503C is displayed between the contact location of the first sliding operation and the identifier 501D of the first team. An arrow direction of the connection symbol 503C represents a direction of the first sliding operation.

In this embodiment of this disclosure, through display of the connection symbols between the contact location of the sliding operation and the identifier and the control, the user learns a current selection state, thereby improving human-computer interaction efficiency, and reducing a memory burden on the user.

In some embodiments, FIG. 3B is a schematic flowchart of an interaction processing method for a virtual scene according to an embodiment of this disclosure. During operation 303, operation 3031 of displaying a plurality of candidate routes, and displaying route identifiers respectively corresponding to the plurality of candidate routes is performed.

In an example, the candidate routes may be preset. Still referring to FIG. 5A, the position of the first camp is at the first location 503A, the position of the second camp is at the second location 504, and three candidate routes, namely, a first route 505A, a second route 506A, and a third route 507A exist between the first location 503A and the second location 504. Still referring to FIG. 5D, when the identifier 501D of the first team is displayed in the selected state, the route identifier 505C of the first route 505A, a route identifier 506C of the second route 506A, and a route identifier 507C of the third route 507A are displayed.

In some embodiments, the candidate routes may have the same ending point or different ending points. In this embodiment of this disclosure, a description is provided by using a virtual scene in which the candidate routes exemplified in FIG. 5A have the same ending point as an example.

In some embodiments, operation 3031 may be implemented in the following manner: displaying a route identifier corresponding to each candidate route at a target location in each candidate route.

In an example, the target location is a unique location of each candidate route. For example, the target location of each candidate route is at a different location in the virtual scene. The target location of the candidate route may be an ending point or a middle point of the candidate route, or may be a barrier or a virtual building through which the route passes.

In some embodiments, FIG. 3C is a schematic flowchart of an interaction processing method for a virtual scene according to an embodiment of this disclosure. After operation 3031, i.e., before a travelling route of the first team is displayed in the selected state, operation 3032 of determining a route identifier at a released location of the first sliding operation as a target route identifier, and determining a candidate route corresponding to the target route identifier as the travelling route of the first team is performed.

Still referring to FIG. 5E, in a case that the first sliding operation is maintained, in response to the first sliding operation passing through the route identifier 505C, the first route 505A corresponding to the route identifier 505C is used as the travelling route of the first team.

In this embodiment of this disclosure, selection of different types of options is achieved through a single sliding operation, which improves the interaction efficiency in the virtual scene, and reduces operation difficulty, thereby reducing computing resources required for the virtual scene, and improving user experience.

In some embodiments, FIG. 3D is a schematic flowchart of an interaction processing method for a virtual scene according to an embodiment of this disclosure. After operation 3031, operation 3033 of displaying the identifier of the first team in a non-selected state in replacement of the selected state in response to no route identifier existing at the released location of the first sliding operation is performed.

In an example, the displaying the identifier of the first team in a non-selected state means recovering the identifier of the first team in the selected state to an original display manner before the identifier of the first team is selected. FIG. 5D is used as an example. The identifier 501D of the first team in FIG. 5D is recovered to the identifier 501B of the first team in FIG. 5B. The first team abandoning the selection may be re-selected.

In some embodiments, FIG. 3E is a schematic flowchart of an interaction processing method for a virtual scene according to an embodiment of this disclosure. During operation 3031, operation 3034 of displaying a route attribute corresponding to each candidate routes is performed.

In an example, the route attribute may be displayed on each candidate route in an overlapping manner. The route attribute includes at least one of a usage frequency of the candidate route, time at which the candidate route was used last time, and a quantity of times of arrival through the candidate route earlier than another route.

FIG. 7C is a schematic diagram of a human-computer interaction interface according to an embodiment of this disclosure. Route attribute prompt information 706 corresponding to each candidate route is displayed near a route identifier of the candidate route. An ellipsis in the route attribute prompt information 706 represents content of the route attribute.

In this embodiment of this disclosure, display of the route attribute helps the user select a route suitable for each team, thereby improving user experience and the interaction efficiency of the virtual scene.

In some embodiments, still referring to FIG. 3E, during operation 3031, operation 3035 of displaying a candidate route of the plurality of candidate routes with a highest winning probability in the selected state is performed.

In an example, the winning probability is targeted for the first team. Operation 3035 and operation 3034 may be performed simultaneously. Still referring to FIG. 7C, compared to FIG. 5C, the route identifier 506C is displayed in the selected state in FIG. 7C. The route identifier 506C is the candidate route with the highest winning probability corresponding to the first team.

In some embodiments, before operation 3035, the candidate route with the highest winning probability may be determined in the following manner: calling a first machine learning model based on a state parameter of the first team (for example, a sum of the state parameters of the plurality of virtual objects in the first team) and the plurality of candidate routes to perform winning probability prediction, to obtain a winning probability corresponding to each candidate route, and determining the candidate route with the highest winning probability.

The first machine learning model is trained based on battle data. The battle data includes travelling routes of a plurality of teams of different camps in at least one battle, a state parameter of each team, and a battle result. A label corresponding to a travelling route of a victorious team is 1, and a label corresponding to a travelling route of a defeated team is 0.

In an example, the first machine learning model may be a neural network model (for example, a convolutional neural network, a deep convolutional neural network, or a fully connected neural network), a decision tree model, a gradient lifting tree, a multi-layer perceptron, a support vector machine, or the like. The type of the first machine learning model is not specifically limited in this embodiment of this disclosure.

In this embodiment of this disclosure, the candidate route with the highest winning probability is automatically recommended to the user, so that the user selects the travelling route for the team, thereby improving the interaction efficiency in the virtual scene.

In some embodiments, no preset candidate route may exist in the virtual scene. FIG. 3F is a schematic flowchart of an interaction processing method for a virtual scene according to an embodiment of this disclosure. Before operation 304, the travelling route of the first team is determined through the following operation 3041.

Operation 3041: Use a partial trajectory of a trajectory of the first sliding operation overlapping the virtual scene as the travelling route of the first team.

In an example, a starting point of the partial trajectory is a starting point of the travelling route, an ending point of the partial trajectory is an ending point of the travelling route, and a sliding direction of the first sliding operation is a travelling direction of the first team. FIG. 7B is a schematic diagram of a human-computer interaction interface according to an embodiment of this disclosure. A trajectory 705 is the partial trajectory of the trajectory of the first sliding operation overlapping the virtual scene. The trajectory 705 is used as the travelling route of the first team. An arrow direction of the trajectory 705 is the travelling direction of the first team.

In some embodiments, a preset candidate route may exist in the virtual scene. FIG. 3G is a schematic flowchart of an interaction processing method for a virtual scene according to an embodiment of this disclosure. Before operation 304, the travelling route of the first team is determined through the following operation 3042 to operation 3043. Details are described below.

Operation 3042: Obtain a partial trajectory of a trajectory of the first sliding operation overlapping the virtual scene, and obtain a similarity between the partial trajectory and each preset candidate route in the virtual scene.

In an example, the similarity may be obtained in the following manner: obtaining a first location parameter of each point in the partial trajectory and a second location parameter of each point in each candidate route; constructing a first sequence corresponding to the partial trajectory based on a sliding direction of the partial trajectory and the first location parameter; and constructing a second sequence of each candidate route based on a direction of advancement of the candidate route and the second location parameter of each candidate route, obtaining a similarity between each second sequence and the first sequence through a dynamic time warping (DTW), and using the similarity as the similarity between the candidate route and the partial trajectory.

Operation 3043: Use a candidate route with a highest similarity as the travelling route of the first team.

In an example, the plurality of candidate routes may be ranked in descending order based on the similarities ranked in descending order, and a ranking candidate route ranked first (i.e., the candidate route with the highest similarity) in a descending ranking result may be used as the travelling route of the first team. FIG. 7D is a schematic diagram of a human-computer interaction interface according to an embodiment of this disclosure. If a similarity between a trajectory 707 of the first sliding operation and the second route 506A is highest, the route identifier 506C of the second route 506A is displayed in the selected state.

Still refer to FIG. 3A. Operation 304: Display a travelling route of the first team in the selected state in response to the first sliding operation being released. In an example, a travelling route of the first group is displayed in the selected state based on a released location of the first sliding operation when the user selection operation is released.

In an example, the travelling route is set through the first sliding operation. For example, the route identifier corresponding to the candidate route is selected through the first sliding operation, and the candidate route is used as the travelling route, or the partial trajectory of the first sliding operation is used as the travelling route.

In some embodiments, when the first sliding operation is released, a connection symbol starting from the first team control, passing through the identifier of the first team, and pointing to the released location is displayed. Still referring to FIG. 5E, the first sliding operation is released at a location of the route identifier 505C, the connection symbol 503C is displayed between the route identifier 505C and the identifier 501D of the first team, and the arrow direction of the connection symbol 503C represents the direction of the first sliding operation.

In some embodiments, FIG. 4B is a schematic flowchart of an interaction processing method for a virtual scene according to an embodiment of this disclosure. After operation 304, operation 305 to operation 308 are performed. Details are described below.

Operation 305: Maintain the identifier of the first team and the travelling route of the first team in the selected state, to indicate that the identifier of the first team and the travelling route of the first team are not allowed to be repeatedly selected.

In an example, maintaining the selected identifier in the selected state avoids repeated selection by the user, which improves the operation efficiency.

Operation 306: Display the identifiers of the plurality of teams in response to a second clicking/tapping operation performed on the first team control.

Operation 307: Display, in response to a second sliding operation passing through an identifier of a second team, the identifier of the second team in the selected state.

In an example, the second sliding operation is performed starting from a clicking/tapping location of the second clicking/tapping operation while the second clicking/tapping operation being maintained.

Operation 308: Display a travelling route of the second team in the selected state in response to the second sliding operation being released.

In an example, the travelling route is set through the second sliding operation. Principles of operation 306 to operation 308 are related to those of operation 302 to operation 304. During operation 306 to operation 308, the identifier of the first team and the travelling route of the first team displayed in the selected state are in a non-repeatedly selectable state. FIG. 5G is a schematic diagram of a human-computer interaction interface according to an embodiment of this disclosure. During a second round of route selection for the second team, the identifier 501D of the first team and a route identifier 505F of the selected first route 505A are in the non-repeatedly selectable state, and one of the second route 506A and the third route 507A may be selected as the travelling route of the second team. For example, a connection symbol 501G is displayed in response to the second sliding operation passing through the identifier 502B of the second team, a connection symbol 502G is displayed in response to the second sliding operation passing through the route identifier 506C, and the second route 506A corresponding to the route identifier 506C is used as the travelling route of the second team.

In some embodiments, virtual objects of a camp are assigned to more teams in the team assignment manner corresponding to the team control. Operation 302 to operation 304 may be repeated to complete selection of a travelling route of a subsequent team.

In this embodiment of this disclosure, selection of two different types of options, namely, a team and a route is achieved through the first sliding operation starting from the first team control. Compared to a traditional manner in which only one type of option can be selected through each operation, operations are reduced, the interaction efficiency in the virtual scene is improved, and computing resources required for the virtual scene are reduced. In this way, operation difficulty is reduced for a user, and a degree of selection freedom of the user is improved, thereby improving usage experience of the user.

An example of an application of the interaction processing method for a virtual scene in the embodiments of this disclosure in an actual application scenario is described below.

In the related art, in a virtual game scene, if a user needs to assign travelling routes to different teams, the user needs to select a team and a route separately. In other words, two operations are required to determine a route of a team. At least two operations need to be performed for selecting different types of options, which is relatively cumbersome. Alternatively, an order for assigning travelling routes for teams is preset in the virtual scene, and the user successively assigns a route to each team, which reduces a degree of freedom of a selection operation. During use for the first time, a player may not know an effect formed by a current selection operation in the virtual scene, and without guidance, the player may not know a next operation after selecting an option. Because little guidance information exists in the virtual game scene, selecting different types of options requires the user to learn game rules in advance, which results in a relatively heavy memory burden. In the interaction processing method for a virtual scene provided in the embodiments of this disclosure, selection operations for two different types of options, namely, a team and a travelling route corresponding to the team can be achieved through a single sliding operation, which improves the interaction efficiency of the virtual scene.

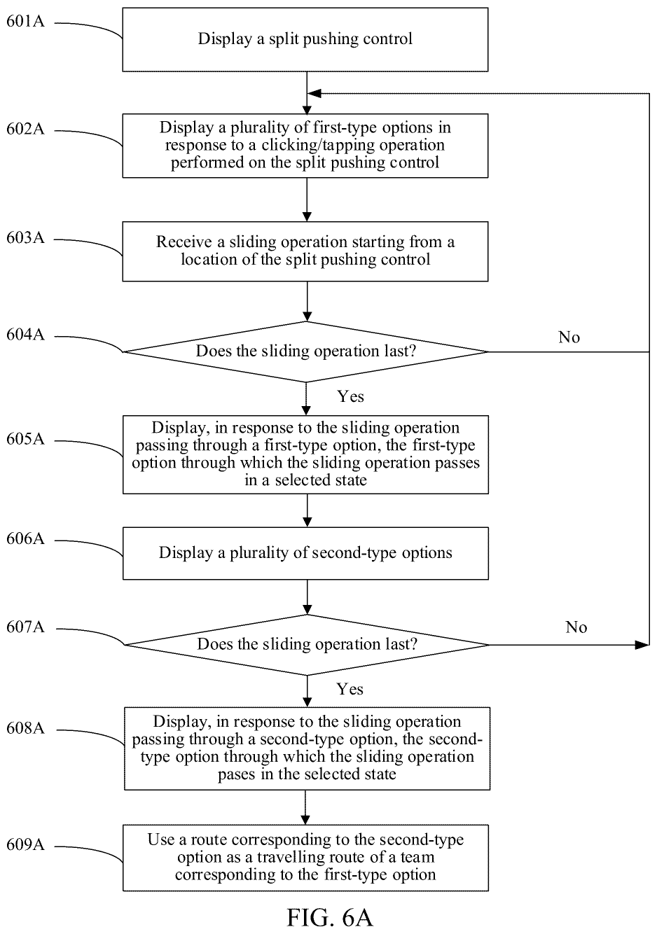

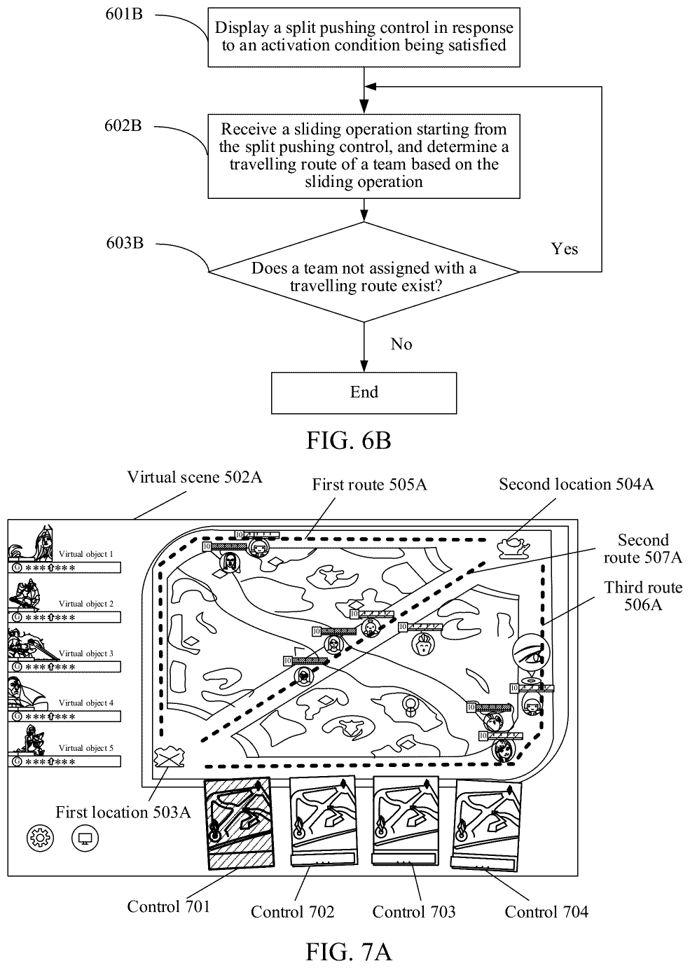

FIG. 6A is a schematic flowchart of an interaction processing method for a virtual scene according to an embodiment of this disclosure. A description is provided with reference to operations shown in FIG. 6A by using an example in which the method is performed by the terminal device 400 in FIG. 1A.

In an example, the virtual scene includes a plurality of virtual objects of at least two camps, each camp defends different positions, and a plurality of routes exist between positions. A first camp may be a partner camp, and a second camp may be a rival camp. In this embodiment of this disclosure, a description is provided in combination with the above examples. For ease of understanding, the virtual scene in the embodiments of this disclosure is described below with reference to the drawings.

FIG. 5A is a schematic diagram of a human-computer interaction interface according to an embodiment of this disclosure. A human-computer interaction interface of the terminal device 400 displays a virtual scene 502A and a plurality of team controls including a first team control 501A. The virtual scene 502A includes two different camps. A position of the first camp is at a first location 503A, and a position of the second camp is at a second location 504A. The first camp includes a virtual object 1, a virtual object 2, a virtual object 3, a virtual object 4, and a virtual object 5. Three routes, namely, a first route 505A, a second route 506A, and a third route 507A exist between the first location 503A and the second location 504A.

Operation 601A: Display a split pushing control.

In an example, the split pushing control (corresponding to the above first team control) is configured to represent assigning a plurality of virtual objects in a camp into different teams based on a preset team assignment manner. For ease of understanding, application of the split pushing control is described below. FIG. 6B is a schematic flowchart of an interaction processing method for a virtual scene according to an embodiment of this disclosure.

Operation 601B: Display the split pushing control in response to an activation condition being satisfied.

In an example, the split pushing control may be displayed as an icon in a form of a card. The activation condition may be any one of the following conditions:

Condition 1: Current locations of the virtual objects in the first camp are advantageous compared to locations of the virtual objects in the rival camp. For example, a distance between any virtual object in the first camp and a position or a virtual building protected by the second camp is less than a distance between the virtual object of the second camp and a position or a virtual building protected by the first camp. It indicates that the virtual object in the first camp is at an advantageous location, and therefore the condition 1 is satisfied.

Condition 2: State parameters (including a virtual resource, a health point, an attack power, and the like) of at least some of the virtual objects in the first camp reach a state parameter threshold.

For example, virtual objects of the first camp and the second camp exist in a game battle, and each camp has five virtual objects. The first camp is used as an example. A virtual object 1, a virtual object 2, a virtual object 3, a virtual object 4, and a virtual object 5 belong to the first camp. In response to a clicking/tapping operation performed on the split pushing control, the five virtual objects of the first camp are respectively assigned to a first team including one virtual object and a second team including four virtual objects based on a preset team assignment manner of the split pushing control. The object 1 belongs to the first team, and the virtual object 2, the virtual object 3, the virtual object 4, and the virtual object 5 belong to the second team.

In an example, when the clicking/tapping operation performed on the split pushing control is received, a first-type option (corresponding to the above identifier of the team) is displayed. The first-type option includes a plurality of team options, such as a first team option (corresponding to the identifier of the first team mentioned above) and a second team option (i.e., the identifier of the second team).

Operation 602B: Receive a sliding operation starting from the split pushing control, and determine a travelling route of a team based on the sliding operation.

In an example, for example, the first-type option and a second-type option are not selected yet. When the sliding operation starting from the split pushing control is received, and the sliding operation passes through any team option of the first-type option, the team of the team option through which the sliding operation passes is selected as a target team, and the second-type option is displayed. The second-type option includes a plurality of route options (corresponding to the above route identifiers). In response to the sliding operation passing through any route option of the second-type option, a route corresponding to the route option through which the sliding operation passes is used as a travelling route of the target team.

Operation 603B: Determine whether a team not assigned with a travelling route exists. When a determination result of operation 603B is yes, operation 602B is repeated. When the determination result of operation 603B is no, the use process of the split pushing control ends.

In an example, when each team is assigned with a corresponding travelling route, the terminal device 400 controls virtual objects in each team to perform actions such as advancement and attacking along the assigned travelling route.

Still refer to FIG. 6A. Operation 602A: Display a plurality of first-type options in response to a clicking/tapping operation performed on the split pushing control.

The clicking/tapping operation is the above first clicking/tapping operation, and the first-type options are the above identifier of the team. FIG. 5B is a schematic diagram of a human-computer interaction interface according to an embodiment of this disclosure. When the clicking/tapping operation performed on the first team control 501A is received, the first team control 501A moves upward from a plurality of team controls to indicate that the first team control 501A is selected, and an identifier 501B of the first team and an identifier 502B of the second team are displayed.

Operation 603A: Receive a sliding operation starting from a location of the split pushing control.

The sliding operation is the above first sliding operation. FIG. 5C is a schematic diagram of a human-computer interaction interface according to an embodiment of this disclosure. A hand 501C of the user performs the sliding operation from the location of the first team control 501A through a finger while the clicking/tapping operation being maintained. A connection symbol 502C is displayed between a contact location of the sliding operation and the starting location of the sliding operation.

Operation 604A: Determine whether the sliding operation lasts. When a determination result of operation 604A is yes, operation 605A of displaying, in response to the sliding operation passing through a first-type option, the first-type option through which the sliding operation passes in a selected state is performed. When the determination result of operation 604A is no, operation 602A is repeated.

In an example, FIG. 5D is a schematic diagram of a human-computer interaction interface according to an embodiment of this disclosure. A picture on the human-computer interaction interface in FIG. 5D is the same as that in FIG. 5C. When the sliding operation passes through the identifier 501B of the first team, the identifier 501B of the first team is displayed in the selected state, which is represented as an identifier 501D of the first team in FIG. 5D.

In an example, when the determination result of operation 604A is no, it indicates that the user releases the hand, i.e., the sliding operation is released. If the released location of the sliding operation is not located in any control or identifier, it is determined that the current selection is canceled. When the sliding operation is received again, selection may be performed again.

After operation 605A, operation 606A of displaying a plurality of second-type options is performed.

The second-type options are the above identifier of the candidate route. Still referring to FIG. 5D, when the identifier 501D of the first team is displayed in the selected state, a route identifier 505C of the first route 505A, a route identifier 506C of the second route 506A, and a route identifier 507C of the third route 507A are displayed.

Operation 607A: Determine whether the sliding operation lasts. When a determination result of operation 607A is yes, operation 608A of displaying, in response to the sliding operation passing through a second-type option, the second-type option through which the sliding operation passes in the selected state is performed. When the determination result of operation 607A is no, operation 602A is repeated.

In an example, a principle of operation 607A is the same as a principle of operation 604A, and therefore details are not described herein.

In an example, FIG. 5E is a schematic diagram of a human-computer interaction interface according to an embodiment of this disclosure. When the sliding operation passes through the route identifier 505C while the sliding operation being maintained, the first route 505A corresponding to the route identifier 505C is used as the travelling route of the first team. A connection symbol 503C is displayed between the contact location of the sliding operation and the identifier 501D of the first team. An arrow direction of the connection symbol 503C represents a direction of the sliding operation. When the sliding operation is released at a location of the route identifier 505C, FIG. 5F is a schematic diagram of a human-computer interaction interface according to an embodiment of this disclosure. The route identifier 505C is displayed as a route identifier 505F, i.e., the route identifier is displayed in the selected state.

After operation 608A, operation 609A of using a route corresponding to the second-type option as a travelling route of a team corresponding to the first-type option is performed.

In an example, the second-type option is selected based on a selection result of the first-type option, and a superposition result of the two type options is finally generated. For example, if the first team and the first route are selected through a single sliding operation, the selection result is dispatching the virtual objects of the first team to travel along the first route.

In an example, after the route of the first team is selected, operation 601A to operation 608A may be repeated to select a route of another team. All selected options are displayed in the selected state (for example, a grayed ticked state), to indicate that the selected options cannot be selected. FIG. 5G is a schematic diagram of a human-computer interaction interface according to an embodiment of this disclosure. During a second round of route selection for the second team, the identifier 501D of the first team and a route identifier 505F of the selected first route 505A are in the non-repeatedly selectable state, and one of the second route 506A and the third route 507A may be selected as the travelling route of the second team. For example, a connection symbol 501G is displayed in response to the second sliding operation passing through the identifier 502B of the second team, a connection symbol 502G is displayed in response to the second sliding operation passing through the route identifier 506C, and the second route 506A corresponding to the route identifier 506C is used as the travelling route of the second team.

The embodiments of this disclosure can achieve the following effects:

A user can first independently determine whether to select a multi-person road or a single person road, which improves a degree of freedom of decision-making, improves user experience, and reduces a memory burden of the user.

Operation complexity is not increased while the degree of freedom of decision-making is improved.

Interaction efficiency is improved, learning costs of the user is reduced, and computing resources required for running the virtual scene are reduced.

An example of a structure of an interaction processing apparatus 455 for a virtual scene provided in the embodiments of this disclosure implemented as a software module is further described below. In some embodiments, as shown in FIG. 2, The interaction processing apparatus 455 for a virtual scene stored in the memory 450 may include the following software modules: a display module 4551, configured to display the virtual scene, and display at least one team control, the virtual scene including a plurality of teams participating in an interaction, the display module 4551 being further configured to display identifiers of the plurality of teams in response to a first clicking/tapping operation performed on a first team control; and a selection module 4552, configured to display, in response to a first sliding operation being performed and the first sliding operation passing through an identifier of a first team, the identifier of the first team in a selected state, the first sliding operation being performed starting from a clicking/tapping location of the first clicking/tapping operation while the first clicking/tapping operation being maintained, the selection module 4552 being further configured to display a travelling route of the first team in the selected state in response to the first sliding operation being released, the travelling route being set through the first sliding operation.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

In some embodiments, during the displaying the identifier of the first team based on a selected state, the selection module 4552 is configured to: display a plurality of candidate routes, and display route identifiers respectively corresponding to the plurality of candidate routes; and determine a route identifier at a released location of the first sliding operation as a target route identifier and determine a candidate route corresponding to the target route identifier as the travelling route of the first team before the displaying a travelling route of the first team in the selected state.

In some embodiments, the selection module 4552 is configured to display a route identifier corresponding to each candidate route at a target location in each candidate route, the target location being a unique location of each candidate route.

In some embodiments, after the displaying a plurality of candidate routes, and displaying route identifiers respectively corresponding to the plurality of candidate routes, the selection module 4552 is configured to display the identifier of the first team in a non-selected state in replacement of the selected state in response to no route identifier existing at the released location of the first sliding operation.

In some embodiments, before the displaying a travelling route of the first team in the selected state, the selection module 4552 is configured to use a partial trajectory of a trajectory of the first sliding operation overlapping the virtual scene as the travelling route of the first team, a starting point of the partial trajectory is a starting point of the travelling route, an ending point of the partial trajectory being an ending point of the travelling route, and a sliding direction of the first sliding operation being a travelling direction of the first team.

In some embodiments, before the displaying a travelling route of the first team in the selected state, the selection module 4552 is configured to: obtain a partial trajectory of a trajectory of the first sliding operation overlapping the virtual scene, and obtain a similarity between the partial trajectory and each preset candidate route in the virtual scene; and use a candidate route with a highest similarity as the travelling route of the first team.

In some embodiments, during the displaying a plurality of candidate routes, and displaying route identifiers respectively corresponding to the plurality of candidate routes, the selection module 4552 is configured to display a route attribute corresponding to each candidate route, the route attribute including at least one of a usage frequency of the candidate route, time at which the candidate route was used last time, and a quantity of times of arrival through the candidate route earlier than another route.

In some embodiments, during the displaying a plurality of candidate routes, and displaying route identifiers respectively corresponding to the plurality of candidate routes, the selection module 4552 is configured to display a candidate route of the plurality of candidate routes with a highest winning probability in the selected state, the winning probability being targeted for the first team.

In some embodiments, before the displaying a candidate route of the plurality of candidate routes with a highest winning probability in the selected state, the selection module 4552 is configured to: call a first machine learning model based on a state parameter of the first team and the plurality of candidate routes to perform winning probability prediction, to obtain winning probabilities respectively corresponding to the candidate routes, and determine the candidate route with the highest winning probability, the first machine learning model being trained based on battle data, the battle data including travelling routes of a plurality of teams of different camps in at least one battle, a state parameter of each team, and a battle result, a label corresponding to a travelling route of a victorious team being 1, and a label corresponding to a travelling route of a defeated team being 0.

In some embodiments, different team controls correspond to different team assignment manners of a plurality of virtual objects in a first camp, and the plurality of teams are obtained by assigning the plurality of virtual objects in the first camp based on a team assignment manner of the first team control.

In some embodiments, before the displaying at least one team control, the display module 4551 is configured to: obtain a total quantity of virtual objects in a first camp and a state parameter of each virtual object; obtain a preset member quantity proportion, the member quantity proportion being a proportion of a quantity of members of each team corresponding to the team control to the total quantity; perform the following processing for each team control: multiplying the total quantity by the member quantity proportion of each team, to obtain the quantity of members of each team; ranking a plurality of virtual objects in descending order based on the state parameter of each virtual object, to obtain a descending ranking list; and ranking the plurality of teams in ascending order based on the quantity of members of each team, to obtain an ascending ranking list; and perform the following processing for each team based on an order of each team in the ascending ranking list: assigning the virtual objects in the descending ranking list based on the quantity of members of the team starting from a head of the descending ranking list, to obtain virtual objects corresponding to each team; and generating a team assignment manner of the team control based on the quantity of members of each team and the virtual objects included in each team.

In some embodiments, when the at least one team control includes a plurality of team controls, the display module 4551 is configured to: display a team control corresponding to a recommended team assignment manner in the selected state; and display a team control corresponding to a non-recommended team assignment manner in a non-selected state.

In some embodiments, before the displaying at least one team control, the display module 4551 is configured to call a second machine learning model based on current battle data of the virtual scene to perform policy prediction, to obtain the recommended team assignment manner, the current battle data including a total quantity of virtual objects in a first camp, a total quantity of virtual objects in a second camp, a state parameter of each virtual object in the first camp, and a state parameter of each virtual object in the second camp; and the second machine learning model being trained based on battle data, the battle data including team assignment manners of different camps in at least one battle, a state parameter of a virtual object of each team, and a battle result, a label corresponding to a team assignment manner of a victorious camp being 1, and a label corresponding to a team assignment manner of a defeated camp being 0.

In some embodiments, the recommended team assignment manner includes at least one of a team assignment manner with a highest winning probability, a team assignment manner with a highest usage frequency, and a team assignment manner used last time.

In some embodiments, after the displaying a travelling route of the first team in the selected state in response to the first sliding operation being released, the display module 4551 is configured to: maintain the identifier of the first team and the travelling route of the first team in the selected state, to indicate that the identifier of the first team and the travelling route of the first team are not allowed to be repeatedly selected; display the identifiers of the plurality of teams in response to a second clicking/tapping operation performed on the first team control; display, in response to a second sliding operation passing through an identifier of a second team, the identifier of the second team in the selected state, the second sliding operation being performed starting from a clicking/tapping location of the second clicking/tapping operation while the second clicking/tapping operation being maintained; and display a travelling route of the second team in the selected state in response to the second sliding operation being released, the travelling route being set through the second sliding operation.

In some embodiments, before the first sliding operation passes through the identifier of the first team, the display module 4551 is configured to: display a connection symbol starting from the first team control and pointing to a current contact location of the first sliding operation; display a connection symbol starting from the first team control, passing through the identifier of the first team, and pointing to a current contact location of the first sliding operation when the first sliding operation passes through the identifier of the first team; and display a connection symbol starting from the first team control, passing through the identifier of the first team, and pointing to a released location when the first sliding operation is released.

An embodiment of this disclosure provides a computer program product, the computer program product including a computer program or a computer-executable instruction, the computer program or the computer-executable instruction being stored in a computer-readable storage medium. A processor of a computer device reads the computer-executable instructions from the computer-readable storage medium, and executes the computer-executable instructions, to cause the computer device to perform the above interaction processing method for a virtual scene in the embodiments of this disclosure.

An embodiment of this disclosure provides a computer-readable storage medium, such as a non-transitory computer-readable storage medium, having computer-executable instructions stored therein, the computer-executable instructions, when executed by a processor, causing the processor to perform the interaction processing method for a virtual scene provided in the embodiments of this disclosure, for example, the interaction processing method for a virtual scene shown in FIG. 3A.

In some embodiments, the computer storage medium may be a memory such as a ferromagnetic random access memory (FRAM), a ROM, a programmable random access memory (PROM), an erasable programmable random access memory (EPROM), an electrically erasable programmable random access memory (EEPROM), a flash memory, a magnetic surface memory, a compact disc, or a compact disc random access memory (CD-ROM), or may be various devices including one of or any combination of the above memories.

In some embodiments, the computer-executable instructions may be written in a programming language of any form (including a compiled or interpreted language, or a declarative or procedural language) in a form of a program, software, a software module, a script, or code, and may be deployed in any form, for example, deployed as a standalone program or as a module, a component, a subroutine, or another unit suitable for use in a computing environment.

In an example, the computer-executable instructions may but may not necessarily correspond to a file in a file system, and may be stored in a part of a file configured for storing other programs or data, for example, stored in one or more scripts in a hyper text markup language (HTML) document, or may be stored in a single file dedicated for a discussed program, or may be stored in a plurality of collaborative files (for example, files configured storing one or more modules, a subprogram, or a code part).

In an example, the computer-executable instructions may be deployed to be executed on one electronic device, on a plurality of electronic devices located at one site, or on a plurality of electronic devices distributed at a plurality of locations and connected by a communication network.

In summary, in the embodiments of this disclosure, selection of two different types of options, namely, a team and a route is achieved through the first sliding operation starting from the first team control. Compared to a traditional manner in which only one type of option can be selected through each operation, operations are reduced, the interaction efficiency in the virtual scene is improved, and computing resources required for the virtual scene are reduced. In this way, operation difficulty is reduced for a user, and a degree of selection freedom of the user is improved, thereby improving usage experience of the user.

The above descriptions are merely some of the embodiments of this disclosure, and are not intended to limit the protection scope of this disclosure. Any modification, equivalent replacement, or improvement made without departing from the spirit and principle of this disclosure falls within the protection scope of this disclosure.

What is claimed is:

1. An interaction processing method for a virtual scene, the method comprising:
displaying the virtual scene and at least one group control element, the virtual scene including a plurality of groups;
displaying identifiers of the plurality of groups when a first user selection operation is performed on a first group control element of the at least one group control element;
displaying, based on a first sliding operation passing through an identifier of a first group of the plurality of groups, the identifier of the first group in a selected state, the first sliding operation starting from an initial location of the first user selection operation while the first user selection operation is maintained; and
displaying a travelling route of the first group in the selected state based on a released location of the first sliding operation when the user selection operation is released, the travelling route being set through the first sliding operation.

2. The method according to claim 1, wherein while the identifier of the first group is displayed in the selected state, the method further comprises:
displaying a plurality of candidate routes;
displaying route identifiers respectively corresponding to the plurality of candidate routes;
determining a route identifier at the released location of the first sliding operation as a target route identifier; and
determining a candidate route corresponding to the target route identifier as the travelling route of the first group.

3. The method according to claim 2, wherein the displaying the route identifiers comprises:
displaying the route identifier corresponding to each candidate route at a target location in each candidate route, the target location being a unique location of each candidate route.

4. The method according to claim 2, further comprising:
displaying the identifier of the first group in a non-selected state when no route identifier exists at the released location of the first sliding operation.

5. The method according to claim 1, further comprising:
using a partial trajectory of a trajectory of the first sliding operation overlapping the virtual scene as the travelling route of the first group, a starting point of the partial trajectory being a starting point of the travelling route, an ending point of the partial trajectory being an ending point of the travelling route, and a sliding direction of the first sliding operation being a travelling direction of the first group.

6. The method according to claim 1, further comprising:
obtaining a partial trajectory of a trajectory of the first sliding operation overlapping the virtual scene;
obtaining a similarity between the partial trajectory and each preset candidate route in the virtual scene; and
determining a candidate route with a highest similarity as the travelling route of the first group.

7. The method according to claim 2, further comprising:
displaying a route attribute corresponding to each candidate route, the route attribute including at least one of a usage frequency of the respective candidate route, time at which the respective candidate route was used last time, and a quantity of times of arrival through the respective candidate route before another route.

8. The method according to claim 2, further comprising:
displaying a candidate route of the plurality of candidate routes with a highest winning probability in the selected state, the winning probability being associated with the first group.

9. The method according to claim 8, further comprising:
calling a first machine learning model based on a state parameter of the first group and the plurality of candidate routes to perform winning probability prediction, to obtain a winning probability corresponding to each candidate route, and determining the candidate route with the highest winning probability,
the first machine learning model being trained based on battle data, the battle data including travelling routes of a plurality of groups of different camps in at least one battle, a state parameter of each group, and a battle result, a label corresponding to a travelling route of a victorious group being 1, and a label corresponding to a travelling route of a defeated group being 0.

10. The method according to claim 1, wherein
different group control elements correspond to different group assignments of a plurality of virtual objects in a first camp, and the plurality of groups are obtained by assigning the plurality of virtual objects in the first camp based on a group assignment of the first group control element.

11. The method according to claim 10, further comprising:
obtaining a total quantity of virtual objects in the first camp and a state parameter of each virtual object;
obtaining a preset member quantity proportion of a quantity of members of each group corresponding to the group control element to the total quantity;
for each group control element,
multiplying the total quantity by the member quantity proportion of each group, to obtain the quantity of members of each group;
ranking a plurality of virtual objects in descending order based on the state parameter of each virtual object, to obtain a descending ranking list; and
ranking the plurality of groups in ascending order based on the quantity of members of each group, to obtain an ascending ranking list; and
for each group based on an order of each group in the ascending ranking list: assigning the virtual objects in the descending ranking list based on the quantity of members of the group starting from a head of the descending ranking list, to obtain virtual objects corresponding to each group; and
generating a group assignment of the group control element based on the quantity of members of each group and the virtual objects included in each group.

12. The method according to claim 1, wherein when the at least one group control element includes a plurality of group control elements, the displaying the at least one group control element comprises:
displaying a group control element corresponding to a recommended group assignment in the selected state; and
displaying a group control element corresponding to a non-recommended group assignment in a non-selected state.

13. The method according to claim 12, further comprising:
calling a second machine learning model based on current battle data of the virtual scene to perform policy prediction, to obtain the recommended group assignment, the current battle data including a total quantity of virtual objects in a first camp, a total quantity of virtual objects in a second camp, a state parameter of each virtual object in the first camp, and a state parameter of each virtual object in the second camp; and
the second machine learning model being trained based on sample battle data, the sample battle data including group assignments of different camps in at least one battle, a state parameter of a virtual object of each group, and a battle result, a label corresponding to a group assignment of a victorious camp being 1, and a label corresponding to a group assignment manner of a defeated camp being 0.

14. The method according to claim 12, wherein the recommended group assignment is based on at least one of:
a highest winning probability, a highest usage frequency, or last usage time.

15. The method according to claim 1, further comprising:
maintaining the identifier of the first group and the travelling route of the first group in the selected state, to indicate that the identifier of the first group and the travelling route of the first group are not allowed to be repeatedly selected;
displaying the identifiers of the plurality of groups based on a second user selection operation performed on the first group control element;
displaying, based on a second sliding operation passing through an identifier of a second group, the identifier of the second group in the selected state, the second sliding operation starting from an initial location of the second user selection operation while the second user selection operation is maintained; and
displaying a travelling route of the second group in the selected state when the second sliding operation is released, the travelling route being set through the second sliding operation.

16. The method according to claim 1, further comprising:
displaying a connection symbol that points from the first group control element to a current contact location of the first sliding operation;
when the first sliding operation passes through the identifier of the first group, the method further comprises:
displaying a connection symbol that points from the first group control element, through the identifier of the first group, and to a current contact location of the first sliding operation; and
when the first sliding operation is released, the method further comprises:
displaying a connection symbol that points from the first group control element, through the identifier of the first group, and to the released location.

17. An information processing apparatus for a virtual scene, the apparatus comprising:
processing circuitry configured to:
display the virtual scene and at least one group control element, the virtual scene including a plurality of groups;
display identifiers of the plurality of groups when a first user selection operation is performed on a first group control element of the at least one group control element;
display, based on a first sliding operation passing through an identifier of a first group of the plurality of groups, the identifier of the first group in a selected state, the first sliding operation starting from an initial location of the first user selection operation while the first user selection operation is maintained; and
display a travelling route of the first group in the selected state based on a released location of the first sliding operation when the user selection operation is released, the travelling route being set through the first sliding operation.

18. The apparatus according to claim 17, wherein the processing circuitry is configured, while the identifier of the first group is displayed in the selected state, to:
display a plurality of candidate routes;
display route identifiers respectively corresponding to the plurality of candidate routes;
determine a route identifier at the released location of the first sliding operation as a target route identifier; and
determine a candidate route corresponding to the target route identifier as the travelling route of the first group.

19. The apparatus according to claim 18, wherein the processing circuitry is configured to:
display the route identifier corresponding to each candidate route at a target location in each candidate route, the target location being a unique location of each candidate route.

20. A non-transitory computer-readable storage medium, storing instructions which when executed by a processor cause the processor to perform:
displaying a virtual scene and at least one group control element, the virtual scene including a plurality of groups;
displaying identifiers of the plurality of groups when a first user selection operation is performed on a first group control element of the at least one group control element;
displaying, based on a first sliding operation passing through an identifier of a first group of the plurality of groups, the identifier of the first group in a selected state, the first sliding operation starting from an initial location of the first user selection operation while the first user selection operation is maintained; and
displaying a travelling route of the first group in the selected state based on a released location of the first sliding operation when the user selection operation is released, the travelling route being set through the first sliding operation.
